(19) United States
(12) Patent Application Publication
(10) Pub. No.: US 2024/0287255 A1
(43) Pub. Date: Aug. 29, 2024

(54) HYDROSILYLATION METHOD CATALYSED BY AN IRON COMPLEX

(71) Applicants: Elkem Silicones France SAS, Lyon (FR); CPE Lyon, Villeurbanne (FR); CENTRE NATIONAL DE LA RECHERCHE SCIENTIFIQUE, Paris (FR); UNIVERSITE CLAUDE BERNARD LYON 1, Villeurbanne (FR)

(72) Inventors: James DELORME, Villeurbanne (FR); Raphael MIRGALET, Lyon (FR); Delphine BLANC, Lyon (FR); Vincent MONTEIL, Lyon (FR); Jean RAYNAUD, Villeurbanne (FR)

(21) Appl. No.: 18/686,976

(22) PCT Filed: Aug. 30, 2022
(86) PCT No.: PCT/FR2022/000076

§ 371 Date: Feb. 27, 2024

(30) Foreign Application Priority Data
Aug. 31, 2021 (FR) FR2109052

(51) Int. Cl. C08G 77/08; B01J 31/22; B01J 37/00

(52) U.S. Cl. CPC C08G 77/08; B01J 31/2208; B01J 37/00

(57) ABSTRACT

The present invention relates to a method for hydrosilylation of an unsaturated compound comprising at least one alkene function or one alkyne function with a compound comprising at least one hydrosilane function, said method being catalysed by an iron complex represented by the formula Fe[Si(SiR₃)₃]₂ Lₙ, wherein each R is a hydrogen atom or a hydrocarbon group having 1 to 30 carbon atoms, optionally substituted by one or more halogen atoms, each L is an ether ligand, and n=1, 2 or 3. The present invention also relates to a method for preparing said iron complex, as well as to the use thereof as a catalyst for the hydrosilylation of an alkene or alkyne.

### TECHNICAL FIELD

The present invention relates to hydrosilylation reactions between an alkene or alkyne compound and a compound comprising at least one hydrogen atom bonded to a silicon atom. More specifically, the invention relates to the use of catalysts of a novel type for these reactions. These catalysts make possible in particular the curing by crosslinking of silicone compounds.

### STATE OF THE PRIOR ART

During a hydrosilylation reaction (also known as polyaddition), an unsaturated compound, that is to say one comprising at least one unsaturation of double or triple bond type, reacts with a compound comprising at least one hydrosilyl function, that is to say a hydrogen atom bonded to a silicon atom. This reaction can, for example, be described, in the case of an unsaturation of alkene type, by:

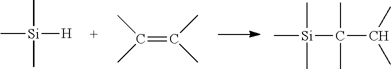

or else, in the case of an unsaturation of alkyne type, by:

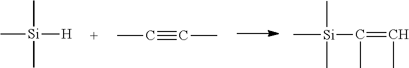

The hydrosilylation reaction can be accompanied, indeed even sometimes replaced, by a dehydrogenative silylation reaction. The reaction can be described by:

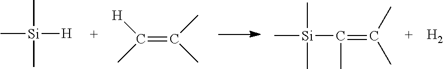

The hydrosilylation reaction is in particular used to crosslink silicone compositions comprising organopolysiloxanes carrying alkenyl or alkynyl units and organopolysiloxanes comprising hydrosilyl functions.

The reaction for the hydrosilylation of unsaturated compounds is typically carried out by catalysis, using metallic or organometallic catalysts. Currently, the appropriate catalyst for this reaction is a platinum catalyst. Thus, the majority of industrial hydrosilylation processes, in particular for the hydrosilylation of alkenes, are catalyzed by Speier hexachloroplatinic acid or by the Karstedt Pt(0) complex of general formula Pt₂(divinyltetramethyldisiloxane)₃ (which may be abbreviated to Pt₂ (DVTMS)₃).

At the start of the 2000s, the preparation of platinum-carbene complexes made it possible to access more stable catalysts (see, for example, the patent application WO 01/42258).

However, the use of metallic or organometallic platinum catalysts is still problematic. It is an expensive metal which is becoming increasingly scarce and the cost of which fluctuates enormously. It is thus difficult use on the industrial scale. It is thus desired to reduce as much as possible the amount of catalyst necessary for the reaction, without, however, reducing the yield and the rate of the reaction. Numerous studies have been carried out to find alternatives to the Karstedt catalyst.

In this context, studies have been carried out for years to find novel catalysts for carrying out the hydrosilylation of alkenes.

For example, the use of iron-based catalysts has been described in the patent application WO 2019/008279. In this document, the catalysts described are iron compounds of general formula [Fe(N(SiR₃)₂)ₓ]_{y}, in which the symbols R represent a hydrogen atom or a hydrocarbon radical, x has the value 1, 2 or 3 and y has the value 1 or 2. It appears that said catalysts were able to efficiently catalyze hydrosilylation or dehydrogenative silylation reactions. These catalysts, in particular, exhibit the advantage of not requiring the use of solvents as they exhibit good solubility in silicone oils. However, in tests of crosslinking of silicone compositions, it is found that the stirring stop times are of the order of several hours.

The patent application US 2016/0023196 describes a mononuclear iron complex exhibiting a catalytic activity for hydrosilylation, hydrogenation and reduction of carbonyl compounds. The iron complex has the general formula [Fe(SiR₃)₂]COₙLₘ, where in particular n has the value 1 to 3. This complex thus necessarily comprises one or more carbonyl ligands coordinated to the iron. According to this document, carbon monoxide CO is an essential ligand making it possible to ensure the catalytic activity.

The international patent application WO 2010/016416 describes a catalyst for a hydrosilylation reaction which comprises an iron complex compound represented by the general formula Xₜ—Fe—R¹ₛ(Yᵤ), in which X represents a ligand chosen from a cyclic structure having an unsaturated aliphatic C₄₋₁₀ group, a trispyrazolylborate, a tetrafluoroborate, a hexafluorophosphate, a porphine and a phthalocyanine, R¹ represents H, an alkyl group, an aryl group or a ligand which is formed by an SiR₃ group, and Y represents a ligand formed by an ammonia molecule, a carbonylated molecule, an oxygen atom, an oxygen molecule, an amine molecule, a phosphine molecule or a phosphite molecule. The only iron complex exemplified is cyclopentadienyl-methyl-dicarbonyl-iron.

It is in this context that the inventors have sought a more effective alternative to the catalysts described above. It is desired to have available a catalyst which can catalyze a hydrosilylation reaction between a hydrosilyl function and an alkene or alkyne function. Advantageously, it is desired that the reaction be rapid and at moderate temperature, preferably at ambient temperature. Furthermore, it is desired that the catalyst contain an abundant, inexpensive and nontoxic chemical element.

More recently, a scientific publication by S. Arata and Y. Sunada (An Isolable Iron(II) Bis(Supersilyl) Complex as an Effective Catalyst for Reduction Reactions, Dalton Trans., 2019, 48, 2891-2895) has described an iron bis-supersilyl complex of formula Fe[Si(SiMe₃)₃]₂(THF)₂ and its activity for the hydrosilylation of carbonyl compounds and for the reductive silylation of molecular nitrogen. However, this publication does not describe the use of these catalysts for the hydrosilylation of alkenes or alkyne. Furthermore, the XRD analysis of the purple crystals obtained in the publication by S. Arata and Y. Sunada indicates that the compound (1) obtained would have the formula C₃₄H₇₀FeO₄Si₈ and a molecular weight of 823.46 g·mol⁻¹ (see Supporting Information of this same paper). The compound isolated in this publication does not correspond to the complex Fe[Si(SiMe₃)₃]₂ (THF)₂.

### SUMMARY OF THE INVENTION

A subject matter of the present invention is a process for the hydrosilylation of an unsaturated compound (A) comprising at least one function chosen from an alkene function and an alkyne function with a compound (B) comprising at least one hydrosilyl function, said process being catalyzed by an iron complex (C) represented by the formula (1):

Fe[Si(SiR₃)₃]₂Lₙ (1)

in which:
each R represents, independently of one another, a hydrogen atom or a hydrocarbon group having from 1 to 30 carbon atoms, optionally substituted by one or more halogen atoms,
each L represents, independently of each other, an ether ligand, and
n=1, 2 or 3.

Another subject matter of the present invention is a composition comprising at least one unsaturated compound (A) comprising at least one function chosen from an alkene function and an alkyne function, at least one compound (B) comprising at least one hydrosilyl function, and an iron complex (C) represented by the formula (1):

Fe[Si(SiR₃)₃]₂Lₙ (1)

in which:
each R represents, independently of one another, a hydrogen atom or a hydrocarbon group having from 1 to 30 carbon atoms, optionally substituted by one or more halogen atoms,
each L represents, independently of each other, an ether ligand, and
n=1, 2 or 3.

Unexpectedly, the inventors have discovered that the iron complex (C) as described above can advantageously be recrystallized in order to efficiently catalyze the hydrosilylation reaction of an alkene or alkyne compound. Another subject matter of the present invention is thus a process for the preparation of an iron complex (C) represented by the formula (1):

Fe[Si(SiR₃)₃]₂Lₙ (1)

in which:
each R represents, independently of one another, a hydrogen atom or a hydrocarbon group having from 1 to 30 carbon atoms, optionally substituted by one or more halogen atoms,
each L represents, independently of each other, an ether ligand, and
n=1, 2 or 3;
   said process comprising a stage of preparation of the crude iron complex (C), followed by a stage of recrystallization of said crude iron complex (C).

The purified iron complex (C), obtained or capable of being obtained by said process, is a subject matter of the present invention, as is its use as catalyst for the hydrosilylation of an alkene or of an alkyne.

### DETAILED DESCRIPTION OF THE INVENTION

In the present text, the symbol [symbol] represents a covalent coordination bond due to the presence in the ligand L of a free electron pair.

Unless otherwise indicated, all the viscosities of the silicone oils with which the present account is concerned correspond to a “Newtonian” dynamic viscosity quantity at 25° C., that is to say the dynamic viscosity which is measured, in a manner known per se, with a Brookfield viscometer at a shear rate gradient which is sufficiently low for the viscosity measured to be independent of the rate gradient.

Although not depicted, the possible tautomeric forms of the compounds described in the present account are included within the scope of the present invention.

In the present invention, an alkyl group can be linear or branched. An alkyl group preferably comprises between 1 and 30 carbon atoms, more preferentially between 1 and 12 carbon atoms, more preferentially still between 1 and 6 carbon atoms. An alkyl group can, for example, be chosen from the following groups: methyl, ethyl, n-propyl, isopropyl, n-butyl, isobutyl, s-butyl, t-butyl, n-pentyl, n-hexyl, n-heptyl, n-octyl, n-nonyl, n-decyl, n-undecyl and n-dodecyl.

In the present invention, a cycloalkyl group can be monocyclic or polycyclic, preferably monocyclic or bicyclic. A cycloalkyl group preferably comprises between 3 and 30 carbon atoms, more preferentially between 3 and 8 carbon atoms. A cycloalkyl group can, for example, be chosen from the following groups: cyclopropyl, cyclo-butyl, cyclopentyl, cyclohexyl, cycloheptyl, cyclooctyl, adamantyl and nobornyl.

In the present invention, an aryl group can be monocyclic or polycyclic, preferably monocyclic, and preferably comprises between 6 and 30 carbon atoms, more preferentially between 6 and 18 carbon atoms. An aryl group can be unsubstituted or be substituted one or more times by an alkyl group. The aryl group can be chosen from the phenyl, naphthyl, anthracenyl, phenanthryl, mesityl, tolyl, xylyl, diisopropylphenyl and triisopropylphenyl groups.

In the present invention, an arylalkyl group preferably comprises between 6 and 30 carbon atoms, more preferentially between 7 and 20 carbon atoms. An arylalkyl group can, for example, be chosen from the following groups: benzyl, phenylethyl, phenylpropyl, naphthylmethyl, naphthylethyl and naphthylpropyl.

In the present invention, the halogen atom can, for example, be chosen from the group consisting of fluorine, bromine, chlorine and iodine, fluorine being preferred. An alkyl group substituted by fluorine can, for example, be trifluoropropyl.

A subject matter of the present invention is a novel process for hydrosilylation between an unsaturated compound (A) and a compound (B) comprising at least one hydrosilyl function catalyzed by an iron complex (C). The iron complex (C) according to the present invention is represented by the formula (1):

Fe[Si(SiR₃)₃]₂Lₙ (1)

in which:
each R represents, independently of one another, a hydrogen atom or a hydrocarbon group having from 1 to 30 carbon atoms, optionally substituted by one or more halogen atoms,
each L represents, independently of each other, an ether ligand, and
n=1, 2 or 3.

Preferably, each R represents, independently of one another, a group chosen from an alkyl group, a cycloalkyl group, an aryl group and an arylalkyl group, it being possible for said groups to be optionally substituted by one or more halogen atoms. More preferably, each R represents, independently of one another, a C₁ to C₁₂ alkyl group, a C₃ to C₈ cycloalkyl group, a C₆ to C₁₂ aryl group or a C₇ to C₂₄ arylalkyl group. More preferably, each R represents, independently of one another, a group chosen from the methyl, ethyl, propyl, 3,3,3-trifluoropropyl, xylyl, tolyl and phenyl groups. More preferably still, the R groups are methyls.

In the formula (1) according to the invention, each L represents an ether ligand, which coordinates the iron by a free electron pair carried by an oxygen atom. n represents the number of ligands L. n has the value 1, 2 or 3. Preferably, n has the value 2. When L has the value 2 or 3, the ligands L can be identical or different. In this formula (1), the iron is in the +II oxidation state.

The ether ligand L can be chosen from the compounds of formula R¹OR², in which R¹ and R² represent, independently of each other, a substituted or unsubstituted hydrocarbon group having from 1 to 30 carbon atoms, optionally comprising one or more heteroatoms, or else R¹ and R² together form, with the oxygen atom to which they are bonded, a cyclic hydrocarbon group comprising one or more heteroatoms. The heteroatom(s) are preferably chosen from O, N, S and P.

According to a first embodiment, R¹ and R² represent, independently of one another, a substituted or unsubstituted hydrocarbon group having from 1 to 30 carbon atoms, optionally comprising one or more heteroatoms. The heteroatom(s) are preferably chosen from O, N, S and P. Preferably, R¹ and R² represent, independently of one another, a group chosen from an alkyl group, a cycloalkyl group, an aryl group and an arylalkyl group, it being possible for said groups to be optionally substituted by one or more halogen atoms, and it being possible for one or more carbon atoms to be optionally replaced by an oxygen atom. More preferably, R¹ and R² represent, independently of one another, a C₁ to C₁₂ alkyl group, a C₃ to C₈ cycloalkyl group, a C₆ to C₁₂ aryl group, a C₇ to C₂₄ arylalkyl group, a (C₁ to C₁₂ alkyl)oxy(C₁ to C₁₂ alkyl) group, a (C₃ to C₈ cycloalkyl)oxy(C₁ to C₁₂ alkyl) group, a (C₆ to C₁₂ aryl)oxy(C₁ to C₁₂ alkyl) group or a (C₇ to C₂₄ arylalkyl)oxy(C₁ to C₁₂ alkyl) group. More preferably, R¹ and R² represent, independently of one another, a group chosen from the methyl, ethyl, propyl, xylyl, tolyl, phenyl, methoxymethyl, methoxyethyl, methoxypropyl, ethoxymethyl, ethoxyethyl, ethoxypropyl, propoxymethyl, propoxyethyl, propoxypropyl, phenyloxymethyl, phenyloxyethyl and phenyloxypropyl groups. The ligand L can, for example, be chosen from the following group: methyl ether, ethyl ether, ethyl methyl ether and dimethoxyethane.

According to a second embodiment, R¹ and R² together form, with the oxygen atom to which they are bonded, a cyclic hydrocarbon group comprising one or more heteroatoms. The heteroatom(s) are preferably chosen from O, N, S and P. The ligand L can be chosen from cyclic compounds, preferably monocyclic compounds, comprising 1 or 2 oxygen atoms and from 2 to 12 carbon atoms, preferably from 2 to 6 carbon atoms, optionally substituted one or more times by a halogen atom. The ligand L can, for example, be chosen from the following groups: tetrahydrofuran, ethylene oxide, 1,3-propylene oxide, tetrahydropyran, oxepane, 1,2-dioxane, 1,3-dioxane and 1,4-dioxane. Preferably, the ligand L can be tetrahydrofuran.

According to very preferred embodiment, the iron complex (C) according to the present invention can be the following compound:

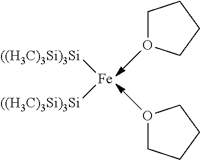

Unexpectedly, the inventors have discovered that the iron complex (C) as described above can advantageously be recrystallized in order to efficiently catalyze the hydrosilylation reaction of an alkene or alkyne compound. Another subject matter of the present invention is thus a process for the preparation of an iron complex (C) as described above, said process comprising a stage of preparation of the crude iron complex (C), followed by a stage of recrystallization of said crude iron complex (C).

The preparation of the crude iron complex (C) can be carried out according to any method known to a person skilled in the art or described in the literature. Reference may be made, for example, to the preparation method described in S. Arata and Y. Sunada, An Isolable Iron(II) Bis(Supersilyl) Complex as an Effective Catalyst for Reduction Reactions, Dalton Trans., 2019, 48, 2891-2895.

According to one embodiment, the preparation of the iron complex (C) can be carried out by reacting an iron(II) halide, for example FeCl₂ or FeBr₂, with an alkaline salt of the supersilylated anion, for example KSi(SiR₃)₃, in the presence of the ligand L. The amount of alkaline salt of the supersilylated anion is at least 2 molar equivalents with respect to the iron halide. The ligand L can be put in excess. Typically, the ligand L can be used as solvent of the reaction. On conclusion of the reaction, the iron complex (C) is separated from the reaction medium and it can optionally be crystallized according to the techniques known to a person skilled in the art. The crude iron complex (C) is thus obtained.

According to the present invention, the crude iron complex (C) is subjected to a recrystallization stage. The recrystallization solvent can be chosen from pentane, toluene, hexane, heptane, cyclopentane, cyclohexane and methylcyclohexane. Preferably, the recrystallization solvent is pentane. The volume of recrystallization solvent can preferably be of between 0.5 ml and 5.0 ml per 100 mg of crude complex, preferably between 1.0 ml and 2.0 ml per 100 mg of crude complex.

The iron complex (C), thus purified, is also a subject matter of the present invention, as is its use as catalyst for the hydrosilylation of an alkene or of an alkyne.

It has been discovered that the iron complex (C) as described above can be used as catalyst for the hydrosilylation reaction between an unsaturated compound (A) comprising at least one function chosen from an alkene function and an alkyne function and a compound (B) comprising at least one hydrosilyl function.

The hydrosilylation reaction can be accompanied by a dehydrogenative silylation reaction. The iron complex (C) as described above can advantageously be used also as catalyst of the dehydrogenative silylation reaction between an unsaturated compound (A) comprising at least one function chosen from an alkene function and an alkyne function and a compound (B) comprising at least one hydrosilyl function. In the present text, and unless otherwise indicated, any commentary or account relating to the hydrosilylation reaction applies to the dehydrogenative silylation reaction.

Another subject matter of the present invention is a composition comprising at least one unsaturated compound (A) comprising at least one function chosen from an alkene function and an alkyne function, at least one compound (B) comprising at least one hydrosilyl function, and an iron complex (C) represented by the formula (1):

Fe[Si(SiR₃)₃]₂Lₙ (1)

in which:
each R represents, independently of one another, a hydrogen atom or a hydrocarbon group having from 1 to 30 carbon atoms, optionally substituted by one or more halogen atoms,
each L represents, independently of each other, an ether ligand, and
n=1, 2 or 3.

The unsaturated compound (A) employed in the hydrosilylation process according to the invention is a chemical compound comprising at least one alkene or alkyne unsaturation not forming part of an aromatic ring. The unsaturated compound (A) comprises at least one function chosen from an alkene function and an alkyne function, preferably at least one function chosen from an alkene function. It can be chosen from those known to a person skilled in the art and which do not contain a reactive chemical function which can interfere with, indeed even prevent, the hydrosilylation reaction.

According to one embodiment, the unsaturated compound (A) comprises one or more alkene functions and from 2 to 40 carbon atoms. According to another embodiment, the unsaturated compound (A) comprises one or more alkyne functions and from 2 to 40 carbon atoms.

The unsaturated compound (A) can preferably be chosen from the group consisting of acetylene, C₁ to C₄ alkyl acrylates and methacrylates, acrylic or methacrylic acid, alkenes, preferably octene and more preferentially 1-octene, allyl alcohol, allylamine, allyl glycidyl ether, allyl piperidinyl ether, preferentially allyl sterically hindered piperidinyl ether, styrenes, preferentially α-methylstyrene, 1,2-epoxy-4-vinylcyclohexane, chlorinated alkenes, preferably allyl chloride, and fluorinated alkenes, preferably 4,4,5,5,6,6,7,7,7-nonafluoro-1-heptene.

The unsaturated compound (A) can be a disiloxane, such as vinylpentamethyldisiloxane and divinyltetramethyldisiloxane.

The unsaturated compound (A) can be chosen from the compounds comprising several alkene functions, preferably two or three alkene functions, and particularly preferably the compound (A) is chosen from the following compounds:

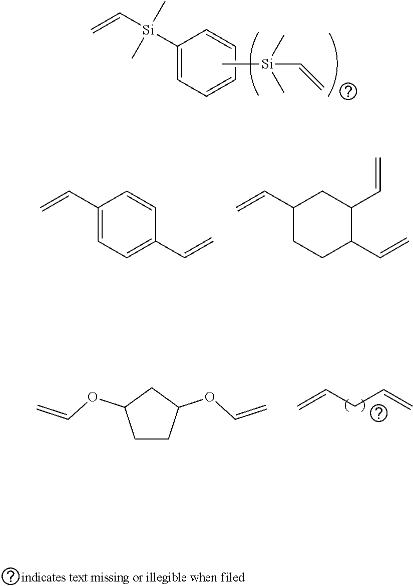

According to a particularly preferred embodiment, the unsaturated compound (A) can be an organopolysiloxane compound comprising one or more alkene functions, preferably at least two alkene functions. The hydrosilylation reaction of alkenes is one of the key reactions of the chemistry of silicones. It makes possible not only the crosslinking between organopolysiloxanes having SiH functions and organopolysiloxanes having alkenyl functions, in order to form networks and to contribute mechanical properties to the materials, but also the functionalization of the organopolysiloxanes having SiH functions, in order to modify their physical and chemical properties. Said organopolysiloxane compound can in particular be formed:
of at least two siloxyl units of following formula: ViₐU_{b}SiO_{(4-a-b)/2}
   in which:
Vi is a C₂-C₆ alkenyl, preferably vinyl, group,
U is a monovalent hydrocarbon group having from 1 to 12 carbon atoms, preferably chosen from the alkyl groups having from 1 to 8 carbon atoms, such as the methyl, ethyl or propyl groups, the cycloalkyl groups having from 3 to 8 carbon atoms and the aryl groups having from 6 to 12 carbon atoms, and
a=1, 2 or 3, preferably a=1 or 2; b=0, 1 or 2; and the sum a+b=1, 2 or 3; and
optionally units of following formula: U_{c}SiO_{(4-c)/2}
in which U has the same meaning as above and c=0, 1, 2 or 3.

It is understood, in the above formulae, that, if several U groups are present, they can be identical to or different from one another.

These organopolysiloxane compounds comprising one or more alkene functions can exhibit a linear structure, essentially consisting of siloxyl units “D” and “D^{Vi}” chosen from the group consisting of the siloxyl units Vi₂SiO_{2/2}, ViUSiO_{2/2} and U₂SiO_{2/2} and of terminal siloxyl units “M” and “M^{Vi}” chosen from the group consisting of the siloxyl units ViU₂SiO_{1/2}, Vi₂USiO_{1/2} and U₃SiO_{1/2}. The symbols Vi and U are as described above.

Mention may be made, as examples of terminal “M” and “M^{Vi}” units, of the trimethylsiloxy, dimethylphenylsiloxy, dimethylvinylsiloxy or dimethylhexenylsiloxy groups.

Mention may be made, as examples of “D” and “D^{Vi}” units, of the dimethylsiloxy, methylphenylsiloxy, methylvinylsiloxy, methylbutenylsiloxy, methylhexenylsiloxy, methyldecenylsiloxy or methyldecadienylsiloxy groups.

Examples of linear organopolysiloxanes which can be organopolysiloxane compounds comprising one or more alkene functions according to the invention are:
a poly(dimethylsiloxane) having dimethylvinylsilyl ends;
a poly(dimethylsiloxane-co-methylphenylsiloxane) having dimethylvinylsilyl ends;
a poly(dimethylsiloxane-co-methylvinylsiloxane) having dimethylvinylsilyl ends;
a poly(dimethylsiloxane-co-methylvinylsiloxane) having trimethylsilyl ends; and
a cyclic poly(methylvinylsiloxane).

In the form most recommended, the organopolysiloxane compound comprising one or more alkene functions contains terminal dimethylvinylsilyl units. More preferentially still, the organopolysiloxane compound comprising one or more alkene functions is a poly(dimethylsiloxane) having dimethylvinylsilyl ends.

A silicone oil generally has a viscosity of between 1 mPa·s and 2 000 000 mPa·s. Preferably, said organopolysiloxane compounds comprising one or more alkene functions are silicone oils with a dynamic viscosity of between 20 mPa·s and 100 000 mPa·s, preferably between 20 mPa·s and 80 000 mPa·s, at 25° C., and more preferentially between 100 mPa·s and 50 000 mPa·s.

Optionally, the organopolysiloxane compounds comprising one or more alkene functions can in addition contain siloxyl units “T” (USiO_{3/2}) and/or siloxyl units “Q” (SiO_{4/2}). The U symbols are as described above. The organopolysiloxane compounds comprising one or more alkene functions then exhibit a branched structure.

Examples of branched organopolysiloxanes, also called resins, which can be organopolysiloxane compounds comprising one or more alkene functions according to the invention, are:
MD^{Vi}Q, where the vinyl groups are included in the D units,
MD^{Vi}TQ, where the vinyl groups are included in the D units,
MM^{Vi}Q, where the vinyl groups are included in a portion of the M units,
MM^{Vi}TQ, where the vinyl groups are included in a portion of the M units,
MM^{Vi}DD^{Vi}Q, where the vinyl groups are included in a portion of the M and D units,
and their mixtures;
   with M^{Vi}=siloxyl unit of formula (U)₂(vinyl)SiO_{1/2}, D^{Vi}=siloxyl unit of formula (U) (vinyl)SiO_{2/2}, T=siloxyl unit of formula (U)SiO_{3/2}, Q=siloxyl unit of formula SiO_{4/2}, M=siloxyl unit of formula (U)₃SiO_{1/2}, and D=siloxyl unit of formula (U)₂SiO_{2/2}, U being as described above.

Preferably, the organopolysiloxane compound comprising one or more alkene functions has a content by weight of alkenyl unit of between 0.001% and 30%, preferably between 0.01% and 10%, preferably between 0.02% and 5%.

The unsaturated compound (A) reacts according to the present invention with a compound (B) comprising at least one hydrosilyl function.

According to one embodiment, the compound (B) comprising at least one hydrosilyl function is a silane or polysilane compound comprising at least one hydrogen atom bonded to a silicon atom. “Silane” compound is understood to mean, in the present invention, the chemical compounds comprising a silicon atom bonded to four hydrogen atoms or to organic substituents. “Polysilane” compound is understood to mean, in the present invention, the chemical compounds possessing at least one ≡Si—Si≡ unit. Among the silane compounds, the compound (B) comprising at least one hydrosilyl function can be phenylsilane or a mono-, di- or trialkylsilane, for example triethylsilane.

According to another embodiment, the compound (B) comprising at least one hydrosilyl function is an organopolysiloxane compound comprising at least one hydrogen atom bonded to a silicon atom, also called organohydropolysiloxane. Said organohydropolysiloxane can advantageously be an organopolysiloxane formed:
of at least two siloxyl units of following formula: H_{d}UₑSiO_{(4-d-e)/2}
   in which:
U is a monovalent hydrocarbon group having from 1 to 12 carbon atoms, preferably chosen from the alkyl groups having from 1 to 8 carbon atoms, such as the methyl, ethyl or propyl groups, the cycloalkyl groups having from 3 to 8 carbon atoms and the aryl groups having from 6 to 12 carbon atoms, and
d=1, 2 or 3, preferably d=1 or 2; e=0, 1 or 2; and d+e=1, 2 or 3; and
optionally other units of following formula: U_{f}SiO_{(4-f)/2}
in which U has the same meaning as above and f=0, 1, 2 or 3.

It is understood, in the above formulae, that, if several U groups are present, they can be identical to or different from one another. Preferentially, U can represent a monovalent radical chosen from the group consisting of the alkyl groups having from 1 to 8 carbon atoms, optionally substituted by at least one halogen atom, such as chlorine or fluorine, the cycloalkyl groups having from 3 to 8 carbon atoms and the aryl groups having from 6 to 12 carbon atoms. U can advantageously be chosen from the group consisting of methyl, ethyl, propyl, 3,3,3-trifluoropropyl, xylyl, tolyl and phenyl.

In the above formula, the symbol d is preferentially equal to 1.

The organohydropolysiloxane can exhibit a linear, branched or cyclic structure. The degree of polymerization is preferably greater than or equal to 2. Generally, it is less than 5000.

When linear polymers are concerned, these essentially consist of siloxyl units chosen from the units of following formulae D: U₂SiO_{2/2} or D′: UHSiO_{2/2}, and of terminal siloxyl units chosen from the units of following formulae M: U₃SiO_{1/2} or M′: U₂HSiO_{1/2}, where U has the same meaning as above.

Examples of organohydropolysiloxanes which can be compounds (B) comprising at least one hydrosilyl function according to the invention are:
a poly(dimethylsiloxane) having hydrodimethylsilyl ends;
a poly(dimethylsiloxane-co-methylhydrosiloxane) having trimethylsilyl ends;
a poly(dimethylsiloxane-co-methylhydrosiloxane) having hydrodimethylsilyl ends;
a poly(methylhydrosiloxane) having trimethylsilyl ends; and
a cyclic poly(methylhydrosiloxane).

When the organohydropolysiloxane exhibits a branched structure, it is preferably chosen from the group consisting of the silicone resins of following formulae:
M′Q, where the hydrogen atoms bonded to silicon atoms are carried by the M groups,
MM′Q, where the hydrogen atoms bonded to silicon atoms are carried by a portion of the M units,
MD′Q, where the hydrogen atoms bonded to silicon atoms are carried by the D groups,
MDD′Q, where the hydrogen atoms bonded to silicon atoms are carried by a portion of the D groups,
MM′TQ, where the hydrogen atoms bonded to silicon atoms are carried by a portion of the M units,
MM′DD′Q, where the hydrogen atoms bonded to silicon atoms are carried by a portion of the M and D units,
and their mixtures,
   with M, M′, D and D′ as defined above, T: siloxyl unit of formula USiO_{3/2} and Q: siloxyl unit of formula SiO_{4/2}, where U has the same meaning as above.

Preferably, the organohydropolysiloxane compound has a content by weight of hydrosilyl Si—H functions of between 0.2% and 91%, more preferentially between 3% and 80% and more preferentially still between 15% and 70%.

According to a particular embodiment of the present invention, it is possible for the unsaturated compound (A) and the component (B) comprising at least one hydrosilyl function to be one and the same compound comprising, on the one hand, at least one ketone function, one aldehyde function, one alkene function and/or one alkyne function and, on the other hand, at least one silicon atom and at least one hydrogen atom bonded to the silicon atom. This compound can then be described as “bifunctional” and it is capable of reacting with itself by a hydrosilylation reaction. The invention can thus also relate to a process for the hydrosilylation of a bifunctional compound with itself, said bifunctional compound comprising, on the one hand, at least one function chosen from the group consisting of a ketone function, an aldehyde function, an alkene function and an alkyne function (preferably at least one alkene function and/or at least one alkyne function) and, on the other hand, at least one silicon atom and at least one hydrogen atom bonded to the silicon atom, said process being catalyzed by an iron complex (C) as described above.

Examples of organopolysiloxanes which can be bifunctional compounds are:
a poly(dimethylsiloxane-co-hydromethylsiloxane-co-vinylmethylsiloxane) having dimethylvinylsilyl ends;
a poly(dimethylsiloxane-co-hydromethylsiloxane-co-vinylmethylsiloxane) having dimethylhydrosilyl ends; and
a poly(dimethylsiloxane-co-hydromethylsiloxane-co-(propyl glycidyl ether)methylsiloxane) having trimethylsilyl ends.

When the use of the unsaturated compound (A) and of the compound (B) comprising at least one hydrosilyl function is concerned, a person skilled in the art understands that this also means the use of a bifunctional compound.

The amounts of compound (A) and of compound (B) can be controlled so that the molar ratio of the hydrosilyl functions of the compounds (B) to the alkene and alkyne functions of the compounds (A) is preferably between 1:10 and 10:1, more preferably between 1:5 and 5:1 and more preferably between 1:3 and 3:1.

The hydrosilylation reaction can be carried out in a solvent or in the absence of solvent. In an alternative form, one of the reactants, for example the unsaturated compound (A), can act as solvent. Appropriate solvents are solvents which are miscible with the compound (B). The hydrosilylation reaction can be carried out at a temperature of between 15° C. and 300° C., preferentially between 20° C. and 240° C., more preferentially between 50° C. and 200° C., more preferentially between 50° C. and 140° C. and more preferentially still between 50° C. and 100° C.

The molar concentration of iron complex (C) can be from 0.01 mol % to 15 mol %, more preferentially from 0.05 mol % to 10 mol %, more preferentially still from 0.1 mol % to 8 mol %, with respect to the total number of moles of unsaturations carried by the unsaturated compound (A). According to another alternative form, the amount of iron employed in the process according to the invention is of between 10 ppm and 3000 ppm, more preferentially between 20 ppm and 2000 ppm and more preferentially still between 20 ppm and 1000 ppm, by weight, with respect to the total weight of the compounds (A), (B) and (C), without taking into account the possible presence of solvent. According to a preferred alternative form, in the process according to the invention, compounds based on platinum, palladium, ruthenium or rhodium are not employed. The amount of compounds based on platinum, palladium, ruthenium or rhodium in the reaction medium is, for example, less than 0.1% by weight, preferably less than 0.01% by weight and more preferentially less than 0.001% by weight, with respect to the weight of the catalyst C.

According to a preferred embodiment of the invention, the compounds (A) and (B) employed are chosen from the organopolysiloxanes as defined above. In this case, a three-dimensional network is formed, which results in the curing of the composition. The crosslinking involves a gradual physical change in the medium constituting the composition. Consequently, the process according to the invention can be used to obtain elastomers, gels, foams, and the like. In this case, a crosslinked silicone material is obtained. The term “crosslinked silicone material” is understood to mean any silicone-based product obtained by crosslinking and/or curing of compositions comprising organopolysiloxanes possessing at least two unsaturated bonds and organopolysiloxanes possessing at least three hydrosilyl units. The crosslinked silicone material can, for example, be an elastomer, a gel or a foam.

Still according to this preferred embodiment of the process according to the invention, where the compounds (A) and (B) are chosen from the organopolysiloxanes as defined above, it is possible to employ usual functional additives in the silicone compositions. Mention may be made, as families of usual functional additives, of:
fillers,
adhesion promoters,
inhibitors or retarders of the hydrosilylation reaction,
adhesion modulators,
silicone resins,
consistency-enhancing additives,
pigments, and
heat resistance, oil resistance or fire resistance additives, for example metal oxides.

Other details or advantages of the invention will become more clearly apparent in the light of the examples given below purely by way of indication.

### EXAMPLES

### Example 1: Synthesis of tris(trimethylsilyl)silyl potassium

1 equivalent of ((CH₃)₃Si)₄Si (5.00 g, 1.56×10⁻² mol) and 1 equivalent of tert-BuOK (1.75 g, 1.56×10⁻² mol) were introduced into a 25-ml Schlenk tube. 5 ml of THF were added. After reacting at ambient temperature for 1 h 30, the solvent was evaporated under dynamic vacuum. After crystallization, washing and drying, the product K[Si(SiMe₃)₃]·1.4THF was obtained in the form of white crystals with a yield of 82.8%.

### Example 2: Synthesis of the Iron Complex (THF)₂Fe[Si(SiMe₃)₃]₂ According to the Prior Art

The synthesis protocol described in S. Arata and Y. Sunada (Dalton Trans., 2019, 48, 2891-2895) was reproduced.

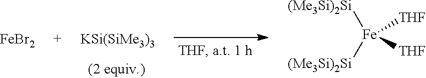

A suspension of FeBr₂ (1.029 g, 4.77×10⁻³ mol) was prepared in 20 ml of THF in a 100-ml Schlenk tube. Two equivalents of K[Si(SiMe₃)₃]1.4THF obtained according to example 1 (3.700 g, 9.54×10⁻³ mol) were dissolved in 15 ml of THF in a 25-ml Schlenk tube. The K[Si(SiMe₃)₃]1.4THF solution was rapidly added dropwise at ambient temperature to the FeBr₂ suspension. After reacting for 1 h, the dark purple solution was centrifuged at 3° C. for 10 minutes in sealed PTFE tubes packaged under argon in order to remove the insoluble materials. After recovering the solution, the solvent was evaporated under dynamic vacuum. The purple solid obtained was subsequently dissolved in 80 ml of pentane. The green solution was subsequently centrifuged at 3° C. for 10 minutes in sealed PTFE tubes packaged under argon in order to remove the insoluble materials. 5 ml of THF were added and then the solution was concentrated to approximately 15% of its initial volume and cooled to −30° C. The complex (THF)₂Fe[Si(SiMe₃)₃]₂ was thus obtained after crystallization in the form of purple crystals which were dried under vacuum (yield: 83.0%).

### Example 3: Synthesis of the Iron Complex (THF)₂Fe[Si(SiMe₃)₃]₂ According to the Invention

The purple crystals obtained in example 2 according to the prior art were recrystallized (1.5 ml of pentane per tranche of 100 mg of crystals).

The complex (THF)₂Fe[Si(SiMe₃)₃]₂ was thus obtained after recrystallization according to the invention with a recrystallization yield of 84%.

The analysis of the crystals obtained in example 3 according to the invention demonstrated that a complex of formula C₂₆H₇₀FeO₂Si₈ and of molecular weight 695.39 g·mol⁻¹ had been obtained. By way of comparison, the purple crystals obtained in the publication of S. Arata and Y. Sunada would correspond, according to the XRD analyses, to a compound of formula C₃₄H₇₀FeO₄Si₈ and a molecular weight of 823.46 g·mol⁻¹ (see Supporting Information, Dalton Trans., 2019, 48, 2891-2895).

### Examples 4-16: Crosslinking Tests

The desired weight of the catalyst was weighed out in a glovebox, under an inert argon atmosphere, and was introduced into dry sealed flasks. The organopolysiloxanes were subsequently introduced into the flasks, still under an inert atmosphere, and then the flasks were placed in the small metal barrel preheated to the desired temperature (t=0). The gel time for the crosslinking tests was measured qualitatively by a stirring stop time (SST). This SST is linked to an increase in the viscosity which is so great that the medium can no longer be stirred (equivalent to a viscosity of approximately 1000 mPa·s).

In examples 4 to 9: the unsaturated compound is a poly(dimethylsiloxane) having dimethylvinylsilyl ends containing from 1.1% to 1.25% by weight of vinyl function; the compound having hydrosilyl function is a poly(methylhydrosiloxane) having trimethylsilyl ends containing 56% by weight of SiH function; SiH/SiVi molar ratio=4; amount of catalyst=7 mol % (molar percentage of iron element contributed by the catalyst with respect to the number of moles of vinyl radicals bonded to silicon contributed by the unsaturated compound); T=30° C.

TABLE 1

| | Catalyst | SST |
|---|---|---|
| Ex. 4 | Cat. of Ex. 2 | 24 h |
| Ex. 5 | (Prior Art) | 45 h |
| Ex. 6 | | 2 h 40 |
| Ex. 7 | Cat. of Ex. 3 | 1 h 45 |
| Ex. 8 | (Invention) | 1 h |
| Ex. 9 | | 1 h 30 |

Under these experimental conditions, the stirring stop time is of between 1 h and 2 h for the reactions catalyzed by the catalyst according to the invention, which has undergone a recrystallization stage (Ex. 7, 8 and 9). In the case of the reactions carried out with the catalyst of the prior art (Ex. 4, 5 and 6), which is not recrystallized, it is found that the test reproducibility is poor and that the stirring stop time is of between 2 h 40 and 45 h.

It is clearly apparent from these examples that the catalyst described in the prior art does not produce the same technical results as the catalyst of the present invention. They are thus physically different.

In examples 10 to 16: the unsaturated compound is a poly(dimethylsiloxane) having dimethylvinylsilyl ends containing from 1.1% to 1.25% by weight of vinyl function; the compound having hydrosilyl function is a poly(methylhydrosiloxane) having trimethylsilyl ends containing 56% by weight of SiH function; SiH/SiVi molar ratio=4; catalyst: recrystallized (THF)₂Fe[Si(SiMe₃)₃]₂ complex of Ex. 3; amount of catalyst=7 mol % (molar percentage of iron element contributed by the catalyst with respect to the number of moles of vinyl radicals bonded to silicon contributed by the unsaturated compound).

TABLE 2

| | Temperature | SST |
|---|---|---|
| Ex. 10 | 30° C. | 1 h 30 |
| Ex. 11 | 40° C. | 50 min |
| Ex. 12 | 50° C. | 30 min |
| Ex. 13 | 60° C. | 20 min |
| Ex. 14 | 70° C. | 30 min |
| Ex. 15 | 80° C. | 30 min |
| Ex. 16 | 90° C. | 30 min |

### Examples 17-22: Functionalization Tests

The desired weight of the catalyst was weighed out in a glovebox, under an inert argon atmosphere, and was introduced into dry sealed flasks. Dodecane (0.3 g) was first introduced. The medium was stirred in order to dissolve the catalyst. First the desired weight of compound having hydrosilyl function and then the desired weight of alkene were introduced into the flasks. The flasks were subsequently placed in the small metal barrel heated beforehand to the desired temperature (t=0).

The reaction medium was analyzed quantitatively by gas chromatography in order to determine the conversions and the selectivities.

In examples 17 to 22: the compound having hydrosilyl function is 1,1,1,3,5,5,5-heptamethyl-3-hydrotrisiloxane (=MD′M); SiH/SiVi molar ratio=1; catalyst: recrystallized (THF)₂Fe[Si(SiMe₃)₃]₂ complex of Ex. 3; amount of catalyst=0.5 mol % (molar percentage of iron element contributed by the catalyst with respect to the number of moles of vinyl radicals bonded to silicon contributed by the unsaturated compound). (Vpdms=vinylpentamethyldisiloxane; Dvtms=divinyltetramethyldisiloxane).

TABLE 3

| | | | | Selectivity of the |
|---|---|---|---|---|
| | | | | hydrosilylation |
| | Unsaturated | | MD'M | (% vs. unsaturated |
| | compound | Temperature | Conversion | compound) |
| Ex. 17 | Vpdms | 30° C. | 20 | 80 |
| Ex. 18 | Vpdms | 60° C. | 22 | 73 |
| Ex. 19 | Vpdms | 90° C. | 11 | 58 |
| Ex. 20 | Dvtms | 30° C. | 12 | 46 |
| Ex. 21 | Dvtms | 60° C. | 26 | 58 |
| Ex. 22 | Dvtms | 90° C. | 22 | 54 |

1. A process for hydrosilylation of an unsaturated compound A comprising at least one function chosen from an alkene function and an alkyne function with a compound B comprising at least one hydrosilyl function, said process being catalyzed by an iron complex C represented by formula (1):
Fe[Si(SiR₃)₃]₂Lₙ (1)
in which:
each R represents, independently of one another, a hydrogen atom or a hydrocarbon group having from 1 to 30 carbon atoms, optionally substituted by one or more halogen atoms,
each L represents, independently of each other, an ether ligand, and
n=1, 2 or 3.

2. The process as claimed in claim 1, in which each R represents, independently of one another, a group chosen from an alkyl group, a cycloalkyl group, an aryl group and an arylalkyl group, it being possible for said groups to be optionally substituted by one or more halogen atoms; optionally, each R represents, independently of one another, a C₁ to C₁₂ alkyl group, a C₃ to C₈ cycloalkyl group, a C₆ to C₁₂ aryl group or a C₇ to C₂₄ arylalkyl group; optionally, each R represents, independently of one another, a group chosen from the methyl, ethyl, propyl, 3,3,3-trifluoropropyl, xylyl, tolyl and phenyl groups; and optionally, the R groups are methyls.

3. The process as claimed in claim 1, in which the ether ligand L is chosen from the compounds of formula R¹OR², in which R¹ and R² represent, independently of each other, a substituted or unsubstituted hydrocarbon group having from 1 to 30 carbon atoms, optionally comprising one or more heteroatoms, or else R¹ and R² together form, with the oxygen atom to which they are bonded, a cyclic hydrocarbon group comprising one or more heteroatoms.

4. The process as claimed in claim 1, in which the iron complex C is the following compound:

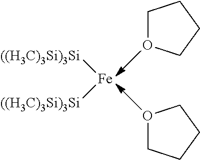

5. The process as claimed in claim 1, in which the unsaturated compound A is an organopolysiloxane compound comprising one or more alkene functions, optionally an organopolysiloxane compound formed:
of at least two siloxyl units of following formula: ViₐU_{b}SiO_{(4-a-b)/2}
in which:
Vi is a C₂-C₆ alkenyl, optionally vinyl group,
U is a monovalent hydrocarbon group having from 1 to 12 carbon atoms, optionally chosen from the alkyl groups having from 1 to 8 carbon atoms, optionally the methyl, ethyl or propyl groups, the cycloalkyl groups having from 3 to 8 carbon atoms and the aryl groups having from 6 to 12 carbon atoms, and
a=1, 2 or 3, optionally a=1 or 2; b=0, 1 or 2; and the sum a+b=1, 2 or 3; and
optionally units of following formula: U_{c}SiO_{(4-c)/2}
in which U has the same meaning as above and c=0, 1, 2 or 3.

6. The process as claimed in claim 1, in which the compound B comprising at least one hydrosilyl function is an organopolysiloxane compound comprising at least one hydrogen atom bonded to a silicon atom, optionally an organopolysiloxane formed:
of at least two siloxyl units of following formula: H_{d}UₑSiO_{(4-d-e)/2}
in which:
U is a monovalent hydrocarbon group having from 1 to 12 carbon atoms, optionally chosen from the alkyl groups having from 1 to 8 carbon atoms, optionally the methyl, ethyl or propyl groups, the cycloalkyl groups having from 3 to 8 carbon atoms and the aryl groups having from 6 to 12 carbon atoms, and
d=1, 2 or 3, optionally d=1 or 2; e=0, 1 or 2; and d+e=1, 2 or 3; and
optionally other units of following formula: U_{f}SiO_{(4-f)/2}
in which U has the same meaning as above and f=0, 1, 2 or 3.

7. A composition comprising at least one unsaturated compound A comprising at least one function chosen from an alkene function and an alkyne function, at least one compound B comprising at least one hydrosilyl function, and a catalyst chosen from the iron complexes C represented by the formula (1):
Fe[Si(SiR₃)₃]₂Lₙ (1)
in which:
each R represents, independently of one another, a hydrogen atom or a hydrocarbon group having from 1 to 30 carbon atoms, optionally substituted by one or more halogen atoms,
each L represents, independently of each other, an ether ligand, and
n=1, 2 or 3.

8. A process for preparation of an iron complex C represented by the formula (1):
Fe[Si(SiR₃)₃]₂Lₙ (1)
in which:
each R represents, independently of one another, a hydrogen atom or a hydrocarbon group having from 1 to 30 carbon atoms, optionally substituted by one or more halogen atoms,
each L represents, independently of each other, an ether ligand, and
n=1, 2 or 3;
said process comprising preparation of the crude iron complex C, followed by recrystallization of said crude iron complex C.

9. An iron complex C obtained or capable of being obtained by the process defined in claim 8.

10. A product comprising the iron complex C as claimed in claim 9 as catalyst for hydrosilylation of an alkene or of an alkyne.
